(19) United States
(12) Patent Application Publication
(10) Pub. No.: US 2011/0161609 A1
(43) Pub. Date: Jun. 30, 2011

(54) INFORMATION PROCESSING APPARATUS AND ITS CONTROL METHOD

(75) Inventors: Kenichi OYAMADA, Yokohama (JP); Yoshiyuki NISHI, Fujisawa (JP)

(73) Assignee: Hitachi, Ltd.

(21) Appl. No.: 12/716,216

(22) Filed: Mar. 2, 2010

(30) Foreign Application Priority Data
Dec. 25, 2009 (JP) 2009-293753

(51) Int. Cl. G06F 12/16; G06F 12/00

(52) U.S. Cl. 711/162; 711/154; 711/E12.001; 711/E12.103

(57) ABSTRACT

Proposed is an information processing apparatus and its control method capable of acquiring the operation results of the same point in time in a plurality of storage apparatuses in a highly reliable manner. With this information processing apparatus connected to a plurality of storage apparatuses and its control method, a time difference between an internal time of the storage apparatus and an internal time of the information processing apparatus is detected regarding each of the plurality of storage apparatuses, a time added with the time difference between the internal time of the storage apparatus and the internal time of the information processing apparatus as an execution time of a predetermined operation is set to the plurality of storage apparatuses at an arbitrary future time, and an execution result of the predetermined operation is collected from each of the plurality of storage apparatuses after the lapse of the future time.

### CROSS REFERENCES

This application relates to and claims priority from Japanese Patent Application No. 2009-293753, filed on Dec. 25, 2009, the entire disclosure of which is incorporated herein by reference.

The present invention generally relates to an information processing apparatus and its control method, and is particularly suitable for application in a remote copy system.

### BACKGROUND

Conventionally, as a method of protecting data against calamities such as earthquakes, fires and floods, and terrorism or the like, a computer system loaded with a so-called remote copy function (hereinafter referred to as the “remote copy system”) for duplicating and retaining data between a primary-side storage apparatus and a secondary-side storage apparatus respectively installed at a local site and a remote site which are separated at approximately 100 to several 100 [km] has been put into practical application.

Remote copy can be broadly classified into two types; namely, synchronous remote copy and asynchronous remote copy. Among the above, synchronous remote copy performs remote copy by reporting the completion of writing to the host apparatus on the condition that data is written into both the primary-side storage apparatus (hereinafter referred to as the “primary storage apparatus”) and the secondary-side storage apparatus (hereinafter referred to as the “secondary storage apparatus”), and asynchronous remote copy performs remote copy by reporting the completion of writing at the stage that data is written into the primary storage apparatus, and adding, at an appropriate timing, attribute information such as a time stamp showing the update time and transferring that data to the secondary storage apparatus.

Incidentally, Japanese Published Unexamined Application No. 2009-123055 discloses, in relation to remote copy technology, setting a plurality of second groups respectively including one or more second volumes in correspondence to each of the first groups of the remote copy source at the remote copy destination, acquiring journals from the first storage apparatus periodically and in the order that they were created for each of the set second groups, and reflecting the acquired journals in the corresponding second volume in the corresponding second group on the one hand, and compares the latest time stamps of each second group contained in the journals which are accumulated in a state of not being reflected in the second volume, detecting the time difference between the latest and oldest time stamps, and acquiring journals of the second group with the oldest time stamp in preference to the journals of other second groups when the time difference exceeds a predetermined threshold.

### SUMMARY

Meanwhile, as a function that is loaded in the host apparatus of the remote copy system, there is a function of collecting, respectively from the primary storage apparatus and the secondary storage apparatus, the operational information representing the operational status thereof, and displaying the collected operational information itself or the operational information of the overall remote copy system that is calculated based on the collected operational information (hereinafter referred to as the “operational information display function”).

Here, as one type of operational information to be presented to the user based on the foregoing operational information display function, there is the delay time of the secondary side in relation to the primary side of the asynchronous remote copy. This delay time is calculated as the difference between the last update time of data in a primary storage apparatus and the last time stamp time of transfer data in a secondary storage apparatus which are configured as a pair in the asynchronous remote copy.

With a conventional remote copy system, the host apparatus issues a status acquisition command to the primary storage apparatus and the secondary storage apparatus, the primary storage apparatus and the secondary storage apparatus that received the status acquisition command notify the host apparatus of the last update time of data and the last time stamp time of transfer data as of the time they respectively received the status acquisition command, and the host apparatus thereby calculated and displayed the delay time based on the foregoing information.

Nevertheless, conventionally, the status acquisition command was issued without giving consideration to the transmission distance or communication path from the host apparatus. In the foregoing case, for instance, even if the host apparatus simultaneously issues the status acquisition command to the primary storage apparatus and the secondary storage apparatus, a time difference will arise between the time that the status acquisition command reaches the primary storage apparatus and the time that the status acquisition command reaches the secondary storage apparatus according to the difference in the transmission distance or communication path from the host apparatus.

Accordingly, according to the conventional method described above, the last update time of data in the primary storage apparatus and the last time stamp time of transfer data in the secondary storage apparatus at the same point in time cannot be accurately collected, and there is a problem in that it is difficult to provide a highly reliable delay time to the user.

In addition, there is a slight variation in the internal time (hereinafter referred to as the “local time”) that is retained by the individual storage apparatuses and, for example, even if the status acquisition command reaches the primary storage apparatus and the secondary storage apparatus at the same timing, the last update time of data in the primary storage apparatus and the last time stamp time of transfer data in the secondary storage apparatus cannot be acquired as operational information at the same local time, and there was a problem in terms of credibility.

The foregoing problems are not limited to the cases of acquiring the last update time of data or the last time stamp time of transfer data from the primary storage apparatus and the secondary storage apparatus, and these problems also arise in cases where it is necessary to collect the operation result of the primary storage apparatus and the secondary storage apparatus at the same point in time.

The present invention was devised in view of the foregoing points. Thus, an object of this invention is to propose an information processing apparatus and its control method capable of acquiring the operation results of the same point in time in a plurality of storage apparatuses in a highly reliable manner.

In order to achieve the foregoing object, the present provides an information processing apparatus connected to a plurality of storage apparatuses. This information processing apparatus comprises a time difference detection unit for detecting a time difference between an internal time of the storage apparatus and an internal time of the information processing apparatus regarding each of the plurality of storage apparatuses, an operation execution setting unit for setting, to the plurality of storage apparatuses at an arbitrary future time, a time added with the time difference between the internal time of the storage apparatus and the internal time of the information processing apparatus as an execution time of a predetermined operation, and an execution result collection unit for collecting an execution result of the predetermined operation from each of the plurality of storage apparatuses after the lapse of the future time.

The present invention additionally provides method of controlling an information processing apparatus connected to a plurality of storage apparatuses. This method comprises a first step of detecting a time difference between an internal time of the storage apparatus and an internal time of the information processing apparatus regarding each of the plurality of storage apparatuses, a second step of setting, to the plurality of storage apparatuses at an arbitrary future time, a time added with the time difference between the internal time of the storage apparatus and the internal time of the information processing apparatus as an execution time of a predetermined operation, and a third step of collecting an execution result of the predetermined operation from each of the plurality of storage apparatuses after the lapse of the future time.

According to the present invention, it is possible to realize an information processing apparatus and its control method capable of acquiring the operation results of the same point in time in a plurality of storage apparatuses in a highly reliable manner.

### DESCRIPTION OF DRAWINGS

FIG. 1 is a block diagram schematically showing the overall configuration of the remote copy system according to an embodiment of the present invention;

FIG. 2 is a conceptual diagram explaining the control program and the control data stored in the memory of the host apparatus;

FIG. 3 is a conceptual diagram explaining the control program and the control data stored in the memory of the storage apparatus;

FIG. 4 is a conceptual diagram showing the configuration of the time difference management table;

FIG. 5 is a conceptual diagram showing the configuration of the local time designation command management table;

FIG. 6 is a conceptual diagram explaining the operational information collection/display function according to an embodiment of the present invention;

FIG. 7 is a conceptual diagram explaining the operational information collection/display function according to an embodiment of the present invention;

FIG. 8 is a conceptual diagram explaining the operational information collection/display function according to an embodiment of the present invention;

FIG. 9 is a conceptual diagram explaining the local time acquisition command;

FIG. 10 is a conceptual diagram explaining the local time designation command;

FIG. 11 is a conceptual diagram explaining the return value;

FIG. 12 is a flowchart showing the sequential processing flow of the CPU of the host apparatus concerning the operational information collection/display function;

FIG. 13 is a flowchart showing the processing routine of the initialization processing;

FIG. 14A is a flowchart showing the processing routine of the local time acquisition processing;

FIG. 14B is a flowchart showing the processing routine of the local time acquisition processing;

FIG. 15 is a flowchart showing the processing routine of the time difference calculation routine;

FIG. 16 is a flowchart showing the processing routine of the execution operation reservation processing; and

FIG. 17 is a flowchart showing the processing routine of the result collection/display processing.

### DETAILED DESCRIPTION

An embodiment of the present invention is now explained in detail with reference to the attached drawings.

### (1) Configuration of Remote Copy System in this Embodiment

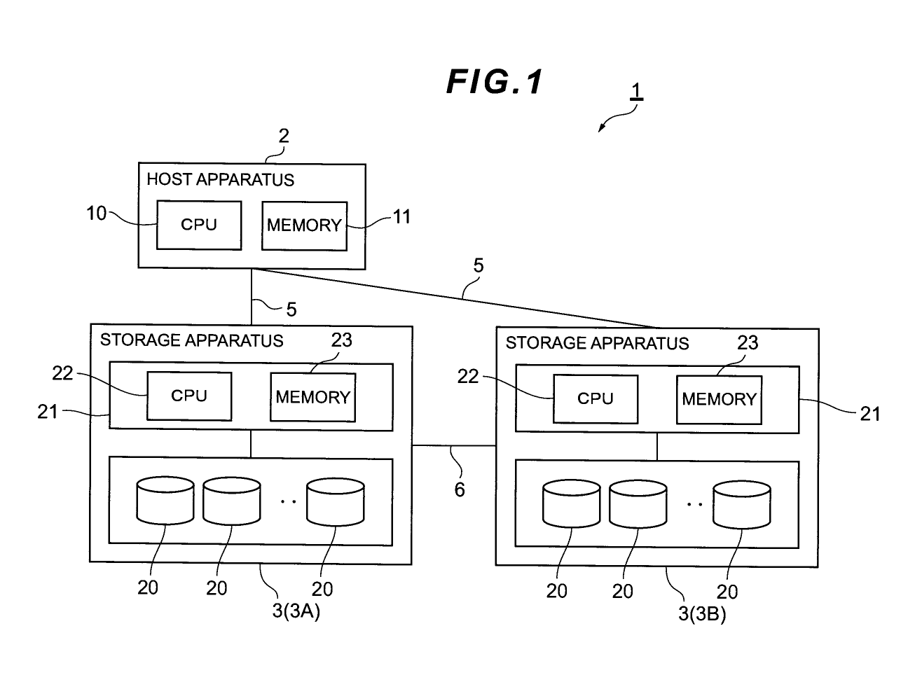

FIG. 1 shows the overall remote copy system 1 according to the present embodiment. The remote copy system 1 comprises a host apparatus 2 installed at a local site, one or more primary storage apparatuses 3 (3A) installed at a local site, and one or more secondary storage apparatuses 3 (3B) installed at a remote site. In the ensuing explanation, if the primary storage apparatus 3A and the secondary storage apparatus 3B do not need to be differentiated, the primary storage apparatus 3A and the secondary storage apparatus 3B are collectively referred to as the storage apparatus 3.

The host apparatus 2 is a computer device comprising information processing resources such as a CPU (Central Processing Unit) 10 and a memory 11, and is configured with, for example, a personal computer, a workstation, a mainframe or the like. The host apparatus 2 is connected to each of the storage apparatuses 3 via a first network 5, and is able to read and write data to and from the primary storage apparatus 3A via the first network 5, and collect necessary information from the respective storage apparatuses 3.

The storage apparatus 3 is respectively configured from a plurality of physical disks 20, and a controller 21 for controlling the reading and writing of data to and from the physical disks 20.

The physical disks 20 are configured, for example, from an expensive disk such as a SCSI (Small Computer System Interface) disk or an inexpensive disk such as a SATA (Serial AT Attachment) disk or an optical disk.

Each physical disk 20 is operated by the controller 21 according to the RAID (Redundant Arrays of Independent Disks) method. One or more logical volumes (hereinafter referred to as the “logical volumes”) are set in a physical storage area that is provided by one or more physical disks 20. Data is stored in units of blocks (hereinafter referred to as the “logical blocks”) or files of a prescribed size in the logical volume.

A unique identifier (hereinafter referred to as the “LUN (Logical Unit number)”) is assigned to each logical volume. In the case of this embodiment, the input and output of data to and from the logical volumes is performed by using the combination of the LUN and a unique number (LBA: Logical Block Address) of the logical block that is assigned to each logical block as the address, and designating such address.

The controller 21 comprises a CPU 22 and a memory 23. The CPU 22 is a processor for governing the operational control of the overall storage apparatus 3. The memory 23 stores various control programs. As a result of the CPU 22 executing the various control programs stored in the memory 23, various types of processing as the overall storage apparatus 3 are performed.

In the case of this embodiment, the primary storage apparatus 3A and the secondary storage apparatus 3B are loaded with an asynchronous remote copy function for performing asynchronous remote copy with the other secondary storage apparatus 3A or the primary storage apparatus 3A.

When the host apparatus 2 writes data into a logical volume in the primary storage apparatus 3A, the primary storage apparatus 3A transfers such data, asynchronously with the writing of data into the logical volume, to the secondary storage apparatus 3B upon adding attribute information such as a time stamp representing the update time or the data write location, and the secondary storage apparatus 3B writes such data into a corresponding location of the corresponding logical volume in the secondary storage apparatus 3B.

### (2) Operational Information Display Function in Host Apparatus

The operational information display function loaded in the host apparatus 2 is now explained. In the case of the remote copy system 1, the host apparatus 2 is loaded with an operational information display function for acquiring the operational information of the same point in time of the primary storage apparatus 3A and the secondary storage apparatus 3B, and displaying the acquired operational information and the operational information of the overall remote copy system 1 that was calculated based on the foregoing operational information.

In reality, the host apparatus 2 acquires the time difference between its own internal time (hereinafter referred to as the “host time”) and the internal time of the respective storage apparatuses 3 (hereinafter referred to as the “local time”), and, based on the acquired time difference, sets different local times to the respective storage apparatuses 3B and an operation (for instance, acquisition of the last update time of data or the last time stamp time of transfer data) to be executed at the local time so as to enable the acquisition of the operational information of same point in time of the primary storage apparatus 3A and the secondary storage apparatus 3B.

The host apparatus 2 thereafter collects the operational information acquired from the primary storage apparatus 3A and the secondary storage apparatus 3B, respectively, according to the operation command, and displays the collected operational information and the operational information of the overall remote copy system (for instance, the delay time of the secondary-side in relation to the primary-side in the asynchronous remote copy) that was calculated based on the foregoing operational information.

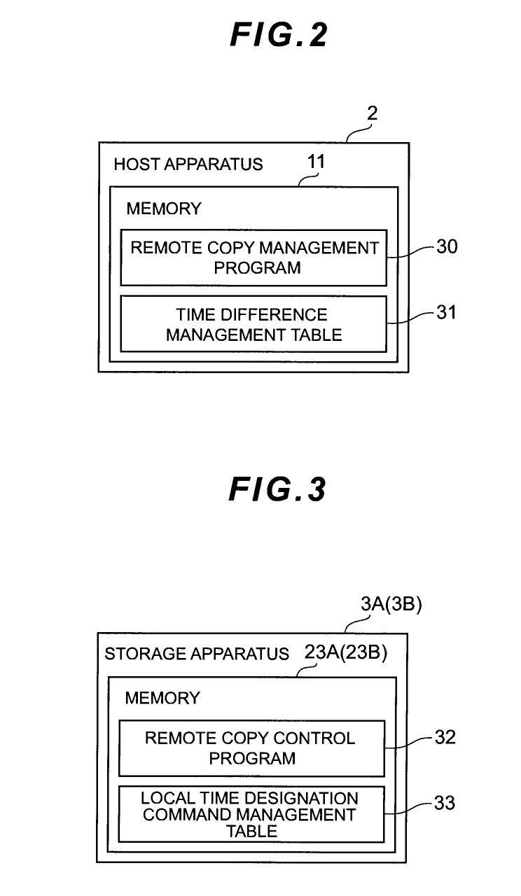

As means for realizing this kind of operational information display function, the memory 11 of the host apparatus 2 stores, as shown in FIG. 2, a time difference management table 31 in addition to a remote copy management program 30 for controlling the asynchronous remote copy to be executed between the primary storage apparatus 3A and the secondary storage apparatus 3B, and the memory 23 of the respective storage apparatuses 3 stores, as shown in FIG. 3, a local time designation command management table 33 in addition to a remote copy control program 32 as a control program for executing the asynchronous remote copy between the primary storage apparatus 3A and the secondary storage apparatus 3B.

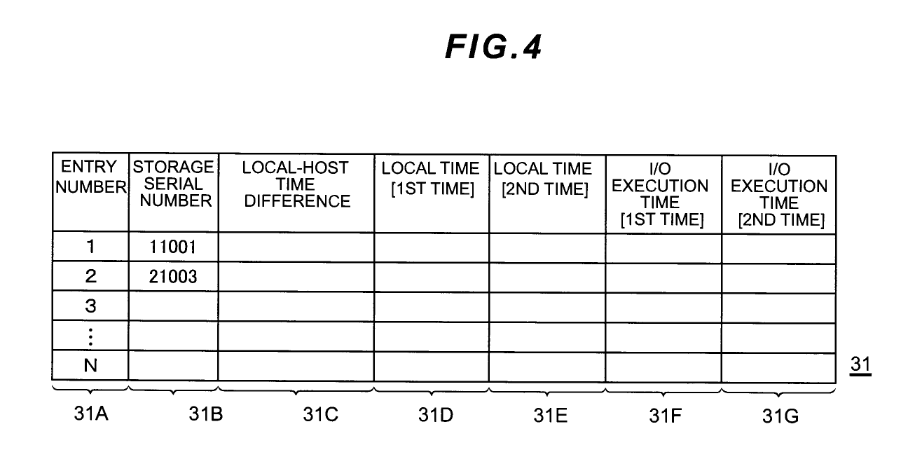

The time difference management table 31 is a table for managing the time difference between the host time and the local time of the respective storage apparatuses 3 that is being managed by the host apparatus 2, and is configured, as shown in FIG. 4, from an entry number column 31A, a storage apparatus serial number column 31B, a local-host time difference column 31C, a first local time column 31D, a second local time column 31E, a first I/O execution time column 31F and a second I/O execution time column 31G.

The entry number column 31A stores the entry number that was assigned to that entry (row). The storage apparatus serial number column 31B stores the serial number of the storage apparatus 3 corresponding to that entry, and the local-host time difference column 31C stores the time difference between the local time of that storage apparatus 3 and the host time.

The first local time column 31D stores the local time of the corresponding storage apparatus 3 that was obtained from the first acquisition processing of the local time described later, and the second local time column 31E stores the local time of that storage apparatus 3 that was obtained from the second acquisition processing of the local time.

The first I/O execution time column 31F stores the time that was required to perform the first acquisition processing of the local time, and the second I/O execution time column 31G stores the time that was required to perform the second acquisition processing of the local time.

Meanwhile, the local time designation command management table 33 is a table for managing the commands issued from the host apparatus 2 in that storage apparatus 3, and is configured from an execution status column 33A, an operation execution local time column 33B, a sub command column 33C, an operation command description column 33D and a result storage buffer column 33E.

The execution status column 33A stores the current execution status of the operation according to the command issued from the host apparatus 2. As the execution status, there are “in execution” which shows that the operation according to the command is being executed, “complete” which shows that the operation is complete, and “no request” which shows that, after the completion of the operation, the information obtained from that operation has not yet been collected by the host apparatus 2.

The operation execution local time column 33B stores the local time (hereinafter referred to as the “operation execution local time”) for executing the operation which was designated by the host apparatus 2 in advance. The operation execution local time is a local time that is determined for causing a plurality of intended storage apparatuses 3 to concurrently execute the intended operations at the same time in consideration of the time difference between the local time of that storage apparatus 3 and the host time as described later. Accordingly, the operation execution local time is often a different value for each storage apparatus 3.

The sub command column 33C stores a sub command contained in the command that is issued from the host apparatus 2. The sub command is information representing the operation to be executed by the storage apparatus 3 (for example, acquisition of the last update time of data or the last time stamp time of transfer data). The operation command description column 33D stores various parameters stored in the sub command column 33C that are required for executing the operations.

The result storage buffer column 33E stores information (last update time of data or last time stamp time of transfer data) obtained as a result of executing the operations stored in the sub command column 33C.

### (3) Outline of Various Types of Processing Concerning Operational Information Display Function

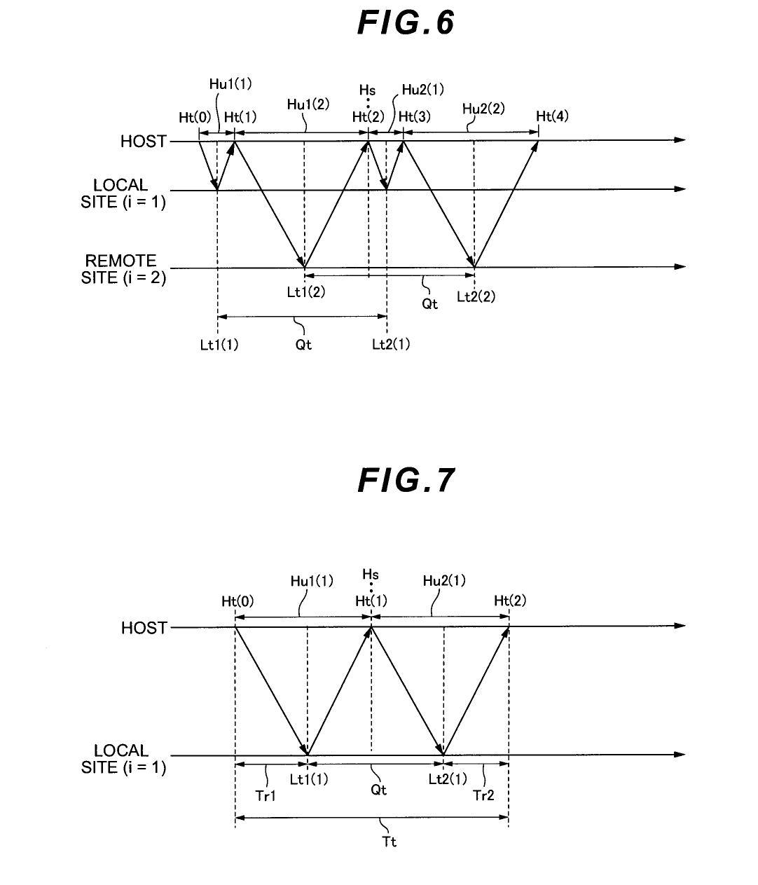

The outline of the various types of processing to be executed in the remote copy system 1 in relation to the operational information display function is now explained with reference to FIG. 6 to FIG. 11. FIG. 6 shows an example of a case where only one primary storage apparatus 3A is installed at the local site, and only one secondary storage apparatus 3B is installed at the remote site.

The host apparatus 2 foremost acquires the current host time Ht(0), and thereafter executes the first acquisition processing of the local time from the respective storage apparatuses 3.

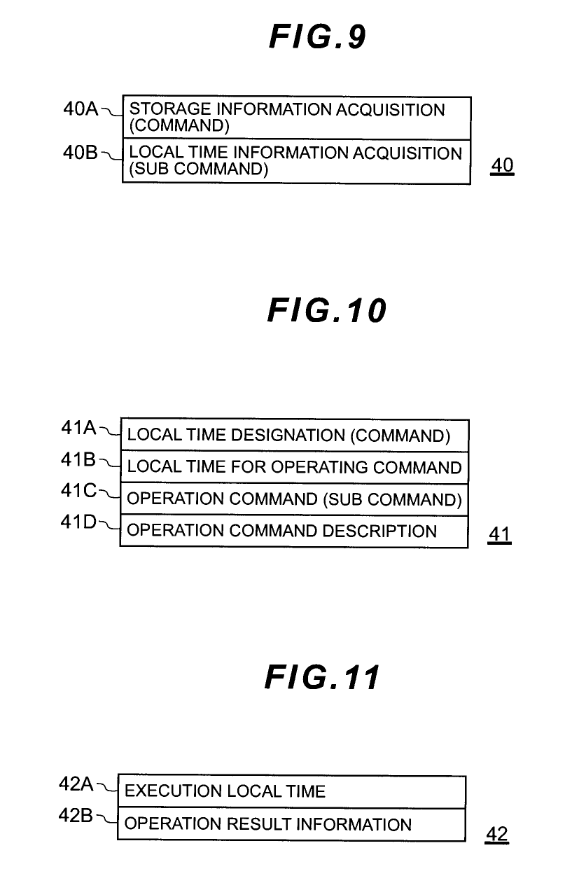

Specifically, the host apparatus 2, as shown in FIG. 6, foremost issues a local time acquisition command 40 as shown in FIG. 9 to the storage apparatus 3 corresponding to the entry with the smallest entry number among the storage apparatuses 3 that are registered in the time difference management table 31 (FIG. 4).

The local time acquisition command 40 is a command for the host apparatus 2 to make an inquiry to the storage apparatus 3 regarding the current local time of that storage apparatus 3, and is configured from a command column 40A storing a command for instructing the storage apparatus 3 to acquire operational information, and a sub command column 40B storing a sub command showing that the operational information to be acquired is the current local time of that storage apparatus 3. The host apparatus 2 thereafter waits for a response from the storage apparatus 3 in response to the local time acquisition command 40.

The storage apparatus 3 that received the local time acquisition command 40 acquires the local time (hereinafter referred to as the “first local time”) Lt1(1) of that storage apparatus 3 at the point in time that it received the local time acquisition command 40, and sends the acquired first local time Lt1(1) to the host apparatus 2 as the response to the local time acquisition command 40.

When the host apparatus 2 receives the first local time Lt1(1) from the storage apparatus 3, it acquires the host time Ht(1) that the point in time that it received the first local time Lt1(1).

Subsequently, the host apparatus 2 seeks the time Hu1(1) (=Ht(1)−Ht(0)) from the time that the local time acquisition command 40 was issued to the storage apparatus 3 up to the time that the response from the storage apparatus 3 in response to the local time acquisition command 40 was received, and stores this in the first I/O execution time column 31F (FIG. 4) of the corresponding entry of the time difference management table 31 (FIG. 4). In the ensuing explanation, the time Hu1(1) from the time that the first local time acquisition command 40 was issued to the storage apparatus 3 up to the time that the response from the storage apparatus 3 in response to the local time acquisition command 40 was received is referred to as the first I/O execution time. The host apparatus 2 stores the acquired first local time Lt1(1) in the first acquisition local time column 31D of that entry.

The host apparatus 2 thereafter executes the same processing to all storage apparatuses 3, in order from the smallest entry number, that are registered in the time difference management table 31. The host apparatus 2 thereby sequentially acquires the first I/O execution time Hu1(i) (i=1, 2, . . . , N) of the respective storage apparatuses 3 registered in the time difference management table 31, and the first local time Lt1(i) (i=1, 2, . . . , N) of such storage apparatuses 3, and registers the acquired first I/O execution time Hu1(i) and the first local time Lt1(i) in the first I/O execution time column 31F and the first local time column 31D of the time difference management table 31, respectively. The variable “i” is the entry number of the corresponding storage apparatus 3 in the time difference management table 31 (FIG. 4).

When the host apparatus 2 completes the first acquisition processing of the local time (first local time Lt1(i)) as described above, it acquires the current host time Ht(N)(Ht(2) in FIG. 6), and stores the acquired host time as the host reference time Hs. The host reference time Hs is the midpoint of the first acquisition processing of the local time and the second acquisition processing of the local time described later, and is a value that is used as the reference upon seeing the difference in the host time and the local time of the respective storage apparatuses 3 as described later.

The host apparatus 2 thereafter executes the second acquisition processing of the local time. Specifically, as with the first acquisition processing of the local time, the host apparatus 2 issues a second local time acquisition command 40 to the storage apparatus 3 corresponding to the entry with the smallest entry number among the storage apparatuses 3 that are registered in the time difference management table 31.

When the host apparatus 2 eventually receives the local time (hereinafter referred to as the “second local time”) Lt2(1) from the storage apparatus 3 at the point in time that it received the local time acquisition command 40 in the storage apparatus 3 in response to the local time acquisition command 40, it acquires the host time Ht(N+1) of the point in time that the response was received.

Subsequently, the host apparatus 2 seeks the time Hu2(1) (=Ht(N+1)−Ht(N)) from the time that the second local time acquisition command 40 was issued to the storage apparatus 3 up to the time that the response from the storage apparatus 3 in response to the local time acquisition command 40 was received, and stores this in the second I/O execution time column 31G (FIG. 4) of the corresponding entry in the time difference management table 31. In the ensuing explanation, the time Hu2(1) from the time that the second local time acquisition command 40 was issued to the storage apparatus 3 up to the time that the response from the storage apparatus 3 in response to the local time acquisition command 40 was received is referred to as the second I/O execution time. The host apparatus 2 stores the acquired second local time Lt2(1) in the second acquisition local time column 31E (FIG. 4) of that entry.

The host apparatus 2 thereafter executes the same processing to all storage apparatuses 3, in order from the smallest entry number, that are registered in the time difference management table 31. The host apparatus 2 thereby sequentially acquires the second I/O execution time Hu2(i) (i=1, 2, . . . , N) of the respective storage apparatuses 3 registered in the time difference management table 31, and the second local time Lt2(i) (i=1, 2, . . . , N) of such storage apparatuses 3, and registers the acquired second I/O execution time Hu2(i) and the second local time Lt2(i) in the second I/O execution time column 31G and the second local time column 31E of the time difference management table 31, respectively. The variable “i” is the entry number of the corresponding storage apparatus 3 in the time difference management table 31 (FIG. 4).

The host apparatus 2 thereafter seeks the difference Qt (=Lt2(i)−Lt1(i)) between the first local time Lt1(i) of that storage apparatus 3 that was acquired based on the issue of the first local time acquisition command 40 and the second local time Lt1(i) that was acquired based on the issue of the second local time acquisition command 40 regarding the respective storage apparatuses 3. Here, the host apparatus 2 uses the average value of all storage apparatuses (i=1, 2, . . . , N) as per the following formula in order to equalize the variations caused by the delay in the I/O.

$$\begin{matrix}[ Formula 1 ] & \\ Qt = \{ {\sum }_{i = 1}^{N} ( Lt 2 ( i ) - Lt 1 ( i ) ) / N \} & ( 1 )\end{matrix}$$

The difference Qt, as shown in FIG. 7, is a value that is obtained by subtracting the transmission time (hereinafter referred to as the “I/O command transmission time”) Tr1 of the local time acquisition command 40 from the host apparatus 2 to the storage apparatus 3 and the transfer time (hereinafter referred to as the “response transfer time”) Tr2 of the response from the storage apparatus 3 to the host apparatus 2 from the total time (that is, the total time of the first and second I/O execution times Hu1(i), Hu2(i)) Tt that was required for acquiring the first local time Lt1(i) and the second local time Lt2(i).

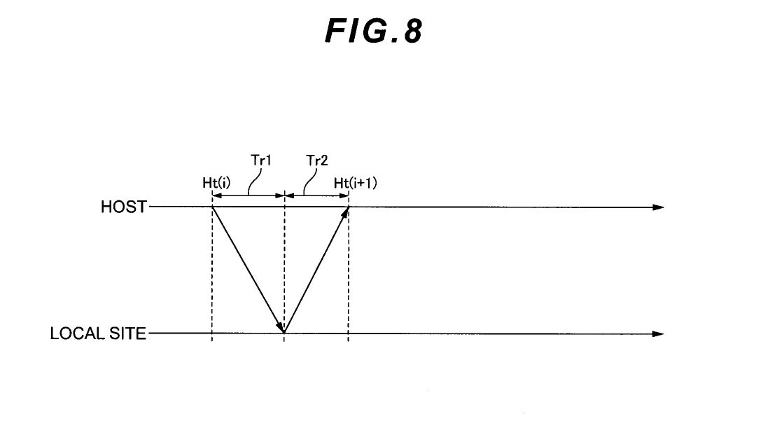

The relation between the transmission time Tr1 of the local time acquisition command 40 from the host apparatus 2 to the storage apparatus 3 and the transfer time Tr2 of the response from the storage apparatus 3 to the host apparatus 2, and the host time Ht(i) is shown in FIG. 8. As evident from FIG. 8, the relation between the I/O command transmission time Tr1 and the response transfer time Tr2, and the host time Ht(i) can be represented as shown in the following formula.

[Formula 2]

Tr1+Tr2=Ht(i+1)−Ht(i) (2)

Here, assuming that the I/O command transmission time Tr1 and the response transfer time Tr2 are the same (Tr1=Tr2), the I/O command transmission time Tr1 and the response transfer time Tr2 will be half the time from the host time Ht(i) to the host time Ht(i+1) as show in the following formula.

[Formula 3]

Tr1=Tr2=(Ht(i+1)−Ht(i))/2 (3)

Subsequently, the host apparatus 2 uses the difference Qt of the first and second local times Lt1(i), Lt2(i) of the respective storage apparatuses 3 sought as described above to seek the time difference (hereinafter referred to as the “local-host time difference”) Dif(i) between the local time of the respective storage apparatuses 3 and the host time in relation to the host reference time Hs based on the following formula.

[Formula 4]

Dif(i)=Hs−[Lt1(i)+Qt×{Hu1(i)/2+B}/{Hu1(i)/2+B+A+Hu2(i)/2}] (4)

In Formula (4), B is a value that is obtained according to the following formula if “i” is greater than 2 upon acquiring the first local time (first local time Lt1(i)):

$$\begin{matrix}[ Formula 5 ] & \\ {\sum }_{j = i + 1}^{N} ( Hu 1 ( j ) ) & ( 5 )\end{matrix}$$

and a value that is obtained according to the following formula if “i” is N:

[Formula 6]

B=0 (6)

Moreover, in Formula (4), A is a value that is obtained according to the following formula if “i” is greater than 2 upon acquiring the second local time (second local time Lt2(i)):

$$\begin{matrix}[ Formula 7 ] & \\ {\sum }_{j = i}^{N - 1} ( Hu 2 ( j ) ) & ( 7 )\end{matrix}$$

and a value that is obtained according to the following formula if “i” is N:

[Formula 8]

A=0 (8)

The host apparatus 2 thereafter decides an arbitrary future time (for example, 5 minutes later) Ht, and additionally calculates the time obtained by adding, to the future time Ht, the local-host time difference Dif(i) of the storage apparatus that was acquired as described above for each storage apparatus 3, and sends a local time designation command 41 as shown in FIG. 10 which designates the calculated time as the operation execution time (hereinafter referred to as the “operation execution local time”) to that storage apparatus 3.

The local time designation command 41 is a command for the host apparatus 2 to designate the intended operation execution local time to the storage apparatus 3 to cause such storage apparatus 3 to execute an intended operation (acquisition of operational information in this example; hereinafter the same) at the operation execution local time, and this command is configured from a command column 41A storing information representing that it is a local time designation command, an operation execution local time column 41B storing the operation execution local time, a sub command column 41C storing a sub command representing the operation to be executed by that storage apparatus, and an operation command description column 41D storing various parameters that are required upon the storage apparatus executing such operation. The host apparatus 2 thereafter waits for a response from the storage apparatus in response to the local time designation command 41.

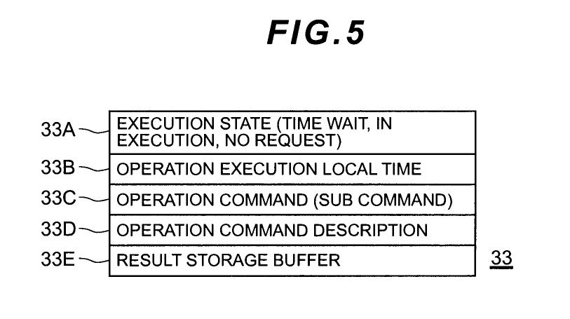

The respective storage apparatuses 3 that received the local time designation command 41 stores the operation execution local time, sub command (operation command), and operation command description respectively designated in the local time designation command 41 in the operation execution local time column 33B, the sub command column 33C and the operation command description column 33D of the local time designation command management table 33 (FIG. 5), respectively.

In addition, the respective storage apparatuses 3 thereafter monitor the operation execution local time column 33B of the local time designation command management table 33. When its own local time eventually becomes the operation execution local time stored in the operation execution local time column 33B, the storage apparatus 3 executes the operation that is stored in the sub command column 33C of the local time designation command management table 33. Thereby, the plurality of storage apparatuses 3 that received the local time designation command 41 will concurrently execute the operation designated in the local time designation command 41 at the same time. In addition, the respective storage apparatuses 3 store the operation result (operational information in this example) obtained from the foregoing operation in the result storage buffer column 33E of the local time designation command management table 33.

Meanwhile, when the host time lapses the foregoing future time Ht, the host apparatus 2 sends a result acquisition command to the respective storage apparatuses 3 that are registered in the time difference management table 31. The respective storage apparatuses 3 that received the foregoing result acquisition command, as shown in FIG. 11, stores the local time at which the corresponding operation was executed in the execution local time 42A, and sends the operation result stored in the result storage buffer column 33E of the local time designation command management table 33 and the return value 42 stored in the operation execution local time column 33B to the host apparatus 2.

Consequently, the host apparatus 2 displays the operational information of the respective storage apparatuses 3 obtained based on the return value 42 sent from the respective storage apparatuses 3, and the operational information of the overall remote copy system 1 that is calculated based on the foregoing operation result.

### (4) Specific Processing of CPU of Host Apparatus in Relation to Operational Information Display Function

(4-1) Overall Flow

The specific processing contents of the CPU 10 (FIG. 1) of the host apparatus 2 in relation to the foregoing operational information display function are now explained. The following sequence of processing is executed based on the foregoing remote copy management program 30 (FIG. 2) that is stored in the memory 11 of the host apparatus 2.

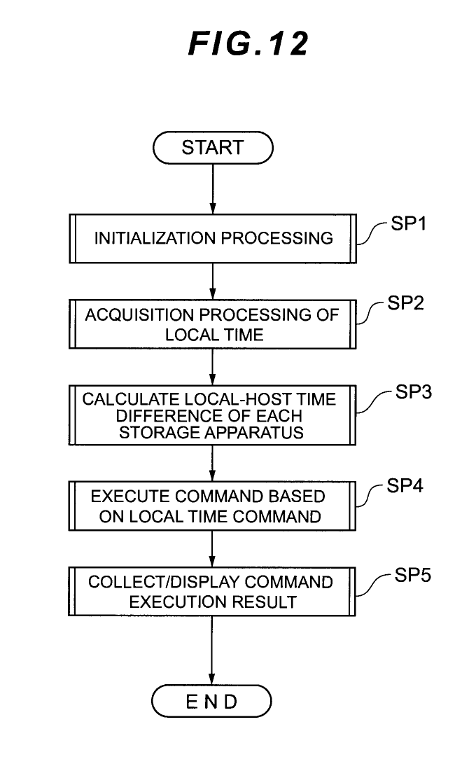

FIG. 12 shows the sequential processing flow of the CPU 10 of the host apparatus 2 in relation to the operational information display function. When a display command of operational information is input based on a user's operation, the CPU 10 foremost initializes the time difference management table 31 (FIG. 4) (SP1), and thereafter acquires the foregoing first and second I/O execution times Hu1(i), Hu2(i) and the first and second local times Lt1(i), Lt2(i) regarding the respective storage apparatuses 3 that are registered in the time difference management table 31 (SP2).

Subsequently, the CPU 10 calculates the local-host time difference Dif(i) of each storage apparatus 3 based on the first and second I/O execution times Hu1(i), Hu2(i) and the first and second local times Lt1(i), Lt2(i) of each storage apparatus 3 obtained in the processing of step SP2 (SP3).

Subsequently, the CPU 10 determines the operation execution local time of each storage apparatus 3 by adding the local-host time difference Dif(i) obtained at step SP3 to the arbitrary future time Ht, and issues a local time designation command 41 (FIG. 10) designating the operation execution local time and the operation to be executed to the respective storage apparatuses 3 that are registered in the time difference management table 31 (SP4).

Subsequently, after the lapse of the future time Ht, the CPU 10 collects the operational information obtained from the respective storage apparatus 3 as a result of executing the operation designated in the local time designation command 41, and displays, on the host apparatus 2, the collected operational information of each storage apparatus 3 and the operational information of the overall remote copy system 1 that was calculated based on the foregoing operational information (SP5).

(4-2) Initialization Processing

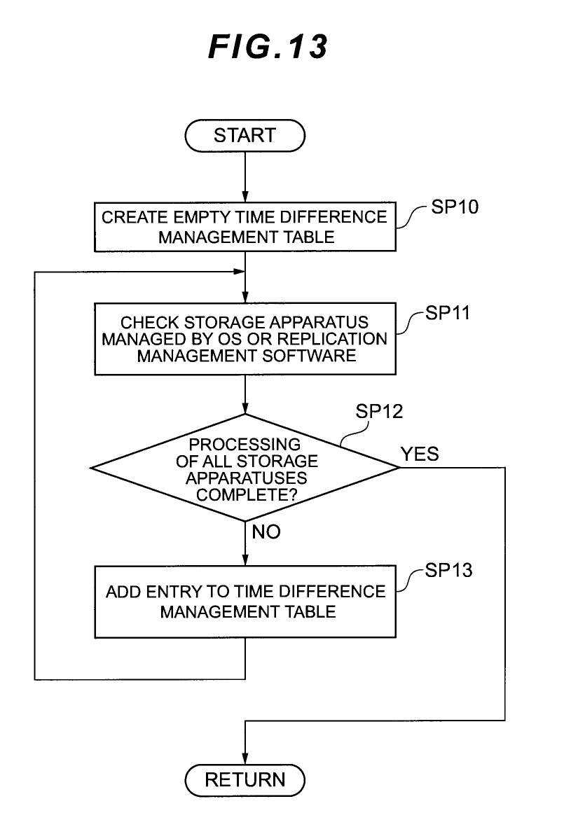

FIG. 13 shows the specific processing routine of the CPU 10 at step SP1 of FIG. 12. The CPU 10 initializes the time difference management table 31 (FIG. 4) according to the processing routine shown in FIG. 13.

Specifically, when the CPU 10 proceeds to step SP1 of FIG. 12, it starts the initialization processing, and foremost creates an empty time difference management table 31 (SP10).

Subsequently, the CPU 10 makes an inquiry to the OS or the remote copy management program 30 regarding the serial number of a storage apparatus 3 that is being managed by the OS or the remote copy management program 30 (FIG. 2) and which is a storage apparatus 3 which has not yet been subject to the processing of step SP13 described later (SP11).

Subsequently, the CPU 10 determines whether the processing of step SP13 has been performed to all storage apparatuses 3 that are being managed by the OS or the remote copy management program 30 based on whether the serial number of any one of the storage apparatuses 3 was acquired in response to the inquiry at step SP11 (SP12).

If the CPU 10 obtains a negative result in the foregoing determination, it adds a new entry to the time difference management table 31, and stores the serial number of the storage apparatus 3 that was obtained from the OS or the remote copy management program 30 in response to the inquiry at step SP11 in the storage apparatus serial number column 31B (FIG. 4) of that entry (SP13). The CPU 10 then returns to step SP11, and thereafter repeats the same processing until it receives a positive result at step SP12.

When the CPU 10 eventually obtains a positive result at step SP12 as a result of not being able to acquire a serial number of any one of the storage apparatuses 3 in response to the inquiry at step SP11, it ends the initialization processing and returns to the processing of FIG. 12.

(4-3) Local Time Acquisition Processing

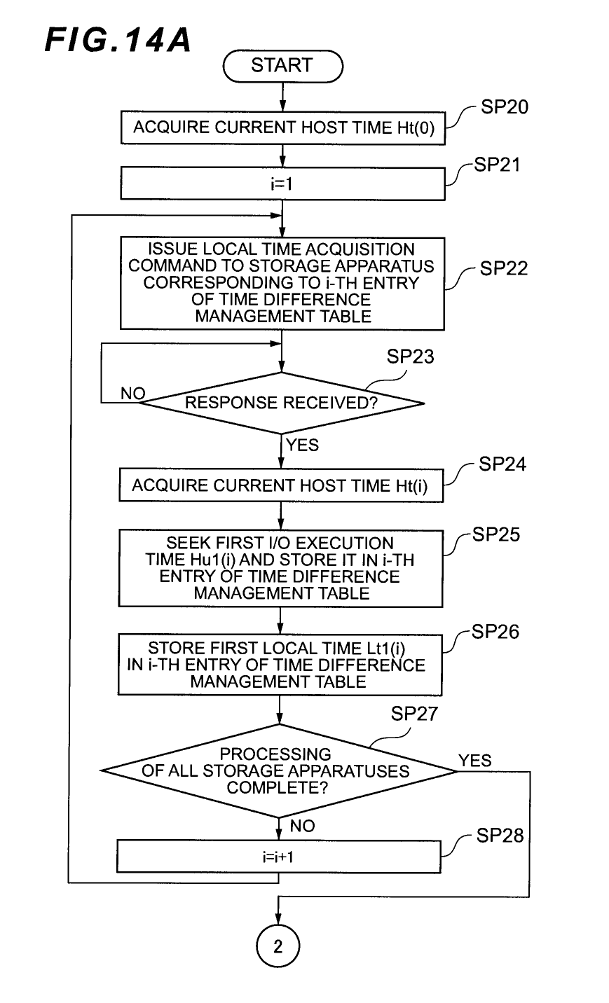

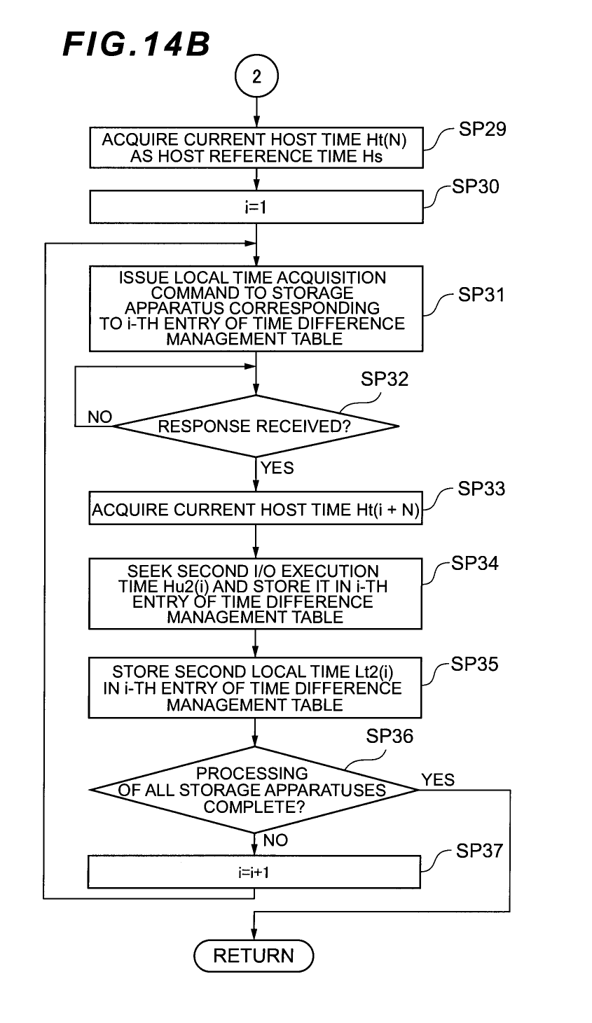

Meanwhile, FIG. 14A and FIG. 14B show the specific processing routine of the CPU 10 at step SP2 of FIG. 12. According to the processing routine shown in FIG. 14A and FIG. 14B, the CPU 10 acquires the first and second I/O execution times Hu1(i), Hu2(i) and the first and second local times Lt1(i), Lt2(i) of the respective storage apparatuses 3 that are registered in the time difference management table 31.

Specifically, when the CPU 10 proceeds to step SP2 of FIG. 12, it starts the local time acquisition processing shown in FIG. 14A and FIG. 14B and foremost acquires the current host time Ht(0) (SP20), and thereafter resets the variable “i” to “1” (SP21).

Subsequently, the CPU 10 issues a local time acquisition command 40 (FIG. 9) to the storage apparatuses 3 in which the entry number in the time difference management table 31 corresponds to the entry of “i” (SP22), and thereafter waits to receive a response from the corresponding storage apparatus 3 in response to the local time acquisition command 40 (SP23).

When the CPU 10 eventually receives the foregoing response, it acquires the current host time Ht(i) (Ht(1) at this stage) (SP24). Moreover, the CPU 10 seeks the first I/O execution time Hu1(i) (Hu1(1) at this stage) based on the foregoing host time Ht(i), and the previously acquired host time Ht(i−1), and stores the sought first I/O execution time Hu1(i) in the first I/O execution time column 31F (FIG. 4) of the “i”-th entry of the time difference management table 31 (SP25).

Subsequently, the CPU 10 stores the local time contained in the response from the corresponding storage apparatus 3 that was received at step SP23 as the first local time Lt1(i) (Lt1(1) at this stage) in the first local time column 31D (FIG. 4) of the “i”-th entry of the time difference management table 31 (SP26).

The CPU 10 thereafter refers to the time difference management table 31 and determines whether the processing of step SP22 to step SP26 has been performed to all storage apparatuses that are registered in the time difference management table 31 (SP27).

If the CPU 10 obtains a negative result in the foregoing determination, it increments the variable “i” (SP28), and thereafter returns to step SP22. The CPU 10 thereafter repeats the same processing until it obtains a positive result at step SP27.

When the CPU 10 obtains a positive result at step SP27 as a result of completing the registration of the first I/O execution time Hu1(i) and the first local time Lt1(i) in the time difference management table 31 for all storage apparatuses 3 that are registered in the time difference management table 31, it acquires the current host time Ht(N) as the host reference time Hs (SP29). The CPU 10 thereafter resets the variable “i” to “1” (SP30).

Subsequently, the CPU 10 once again issues a local time acquisition command 40 (FIG. 9) to the storage apparatuses 3 corresponding to the entry number in the time difference management table 31 in which the entry is “i” (SP31), and thereafter waits to receive a response from the corresponding storage apparatus 3 in response to the foregoing local time acquisition command 40 (SP32).

When the CPU 10 eventually receives the foregoing response, it acquires the current host time Ht(i+N) (SP33). Moreover, the CPU 10 seeks the second I/O execution time Hu2(i) (Hu2(1) at this stage) based on the foregoing host time Ht(i+N) and the previously acquired host time Ht(i−1+N), and stores the sought second I/O execution time Hu2(i) in the second I/O execution time column 31G (FIG. 4) of the “i”-th entry of the time difference management table 31 (SP34).

Subsequently, the CPU 10 stores the local time contained in the response from the corresponding storage apparatus 3 that was received at step SP32 as the first local time Lt2(i) (Lt2(1) at this stage) in the second local time column 31E of the “i”-th entry of the time difference management table 31 (SP35).

The CPU 10 thereafter refers to the time difference management table 31 and determines whether the processing of step SP31 to step SP35 has been performed to all storage apparatuses 3 that are registered in the time difference management table 31 (SP36).

If the CPU 10 obtains a negative result in the foregoing determination, it increments the variable “i” (SP37), and returns to step SP31. The CPU 10 thereafter repeats the same processing until it obtains a positive result at step SP36.

When the CPU 10 eventually obtains a positive result at step SP36 as a result of completing the registration of the second I/O execution time Hu2(i) and the second local time Lt2(i) in the time difference management table 31 for all storage apparatuses 3 that are registered in the time difference management table 31, it ends the local time acquisition processing and returns to the processing of FIG. 12.

(4-4) Time Difference Calculation Routine

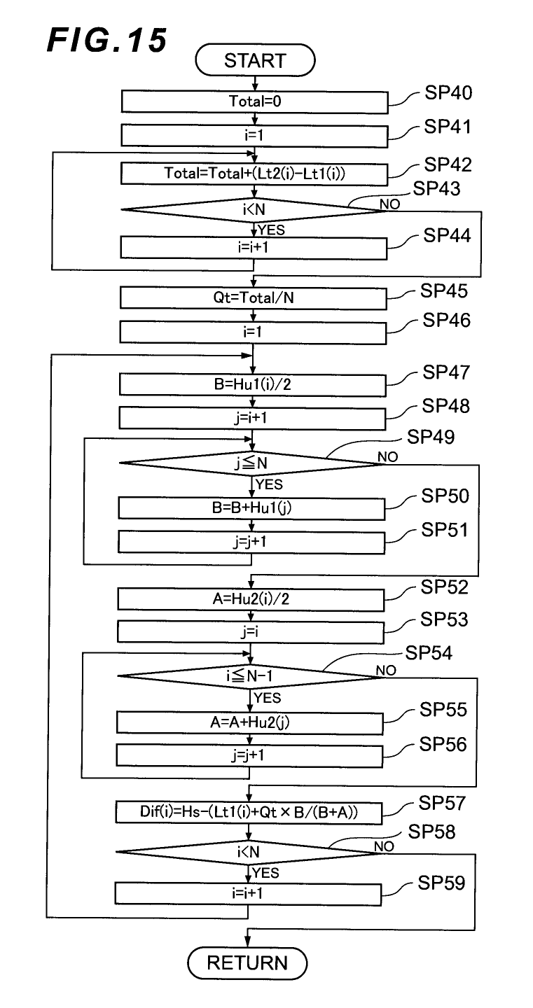

Meanwhile, FIG. 15 shows the specific processing routine of the CPU 10 at step SP3 of FIG. 12. According to the processing routine shown in FIG. 15, the CPU 10 acquires the local-host time difference Dif(i) of the storage apparatus 3 regarding the respective storage apparatuses 3 that are registered in the time difference management table 31.

Specifically, when the CPU 10 proceeds to step SP3 of FIG. 12, it starts the time difference calculation routine shown in FIG. 15, and foremost resets the total difference value to “0” (SP40), and additionally resets the variable “i” to “1” (SP41).

Subsequently, the CPU 10 calculates the new total difference value by adding, to the current total difference value, the difference (Lt2(i)−Lt1(i)) between the second local time Lt2(i) and the first local time Lt1(i) (SP42). Moreover, the CPU 10 determines whether the value of the variable “i” is smaller than the number of storage apparatuses N registered in the time difference management table 31 (SP43).

If the CPU 10 obtains a positive result in the foregoing determination, it increments the variable “i” (SP44). The CPU 10 then returns to step SP42, and thereafter repeats the same processing until it obtains a negative result at step SP43. A value that sums up the differences of the second and first local times Lt2(i), Lt1(i) of the respective storage apparatuses 3 that are registered in the time difference management table 31 is sought as the total difference value.

When the CPU 10 eventually obtains a negative result at step SP43 as a result of completing the processing of step SP42 to step SP44 to all storage apparatuses 3 that are registered in the time difference management table 31, it seeks the foregoing difference Qt as a result of dividing the total difference value that was ultimately sought in the processing at step SP42 to step SP44 with the number of storage apparatuses N registered in the time difference management table 31 (SP45).

Subsequently, the CPU 10 resets the variable “i” to “1” (SP46), and obtains “B” as the value obtained by dividing the first I/O execution time Hu1(i) stored in the first I/O execution time column 31F (FIG. 4) in which the entry number in the time difference management table 31 is the “i”-th entry by “2” (SP47).

The CPU 10 sets a value obtained by adding “1” to the variable “i” as variable “j” (SP48), and determines whether value of the variable “j” is not greater than the number of storage apparatuses N registered in the time difference management table 31 (SP49).

If the CPU 10 obtains a negative result in the foregoing determination, it calculates a new “B” by adding the first I/O execution time Hu1(j) to the value of “B” (SP50), increments the value of the variable “j” (SP51), and thereafter returns to step SP49. The CPU 10 thereafter repeats the processing of step SP49 to step SP51 until it obtains a negative result at step SP49. The value of “B” in Formula (4) is sequentially sought based on the processing of step SP49 to step SP51.

When the CPU 10 eventually obtains a negative result at step SP49, and obtains “A” as the value obtained by dividing the second I/O execution time Hu2(i) stored in the second I/O execution time column 31G (FIG. 4) in which the entry number in the time difference management table 31 is the “i”-th entry by “2” (SP52).

The CPU 10 sets the variable “i” as the variable “j” (SP53), and determines whether the value of the variable “j” is not greater than the value (N−1) that is one less the number of storage apparatuses N registered in the time difference management table 31 (SP54).

If the CPU 10 obtains a negative result in the foregoing determination, it calculates a new “A” by adding the second I/O execution time Hu2(j) to the value of “A” (SP55), increments the value of the variable “j” (SP56), and thereafter returns to step SP54. The CPU 10 thereafter repeats the processing of step SP54 to step SP56 until it obtains a negative result at step SP54. The value of “A” in Formula (4) is sequentially sought based on the processing of step SP54 to step SP56.

When the CPU 10 eventually obtains a negative result at step SP54, it seeks the local-host time difference Dif(i) of the corresponding storage apparatus 3 by executing the computation of Formula (4) (SP57).

Subsequently, the CPU 10 determines whether the value of the variable “i” is less than the number of storage apparatuses N registered in the time difference management table 31 (SP58). If the CPU 10 obtains a positive result in the foregoing determination, it increments the variable “i” (SP59), and thereafter returns to step SP47.

The CPU 10 thereafter repeats the processing of step SP47 to step SP59 until it obtains a positive result at step SP58 while sequentially switching the target storage apparatus 3 to another storage apparatus 3. Consequently, the local-host time difference Dif(i) as the time difference between the local time of the storage apparatus 3 and the host time is sequentially sought regarding the respective storage apparatuses 3 that are registered in the time difference management table 31.

When the CPU 10 eventually obtains a negative result at step SP58 as a result of completing the seeking of the local-host time difference Dif(i) regarding all storage apparatuses 3 that are registered in the time difference management table 31, it ends the time difference calculation routine and returns to the processing of FIG. 12.

(4-5) Execution Operation Reservation Processing

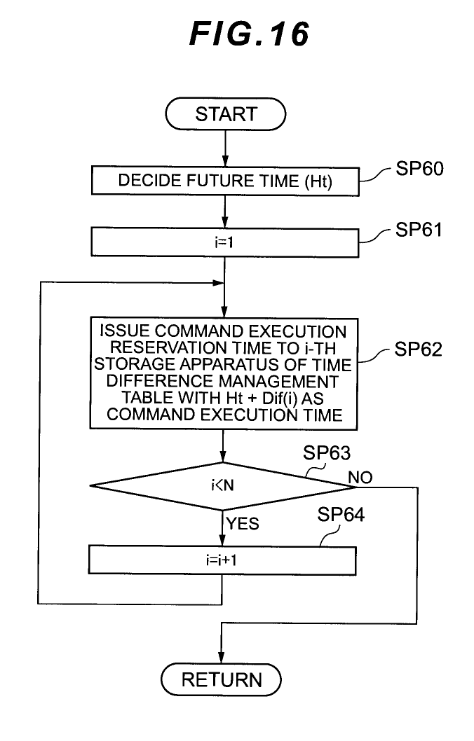

FIG. 16 shows the specific processing routine of the CPU 10 at step SP4 of FIG. 12. According to the processing routine shown in FIG. 16, the CPU 10 sets the operation execution local time and the operation to be executed at the operation execution local time in the respective storage apparatuses 3 that are registered in the time difference management table 31.

Specifically, the CPU 10 foremost decides the foregoing future time Ht (SP60), and thereafter resets the value of the variable “i” to “1” (SP61).

Subsequently, the CPU 10 issues, to the storage apparatuses 3 in which the entry number in the time difference management table 31 corresponds to the “i”-th entry, a local time designation command 41 (FIG. 10) that designates, as the operation execution local time, a value obtained by adding the corresponding local-host time difference Dif(i) calculated in the time difference calculation routine of FIG. 15 to the future time Ht decided at step SP60 in relation to the storage apparatuses 3 in which the entry number in the time difference management table 31 corresponds to the “i”-th entry, and designates an intended operation (acquisition of operational information in this example) as the sub command (SP62).

Subsequently, the CPU 10 determines whether the value of the variable “i” is less than the number of storage apparatuses N registered in the time difference management table 31 (SP63). If the CPU 10 obtains a positive result in the foregoing determination, it increments the variable “i” (SP64), returns to step SP62, and thereafter repeats the same processing until it obtains a negative result at step SP63.

When the CPU 10 eventually obtains a negative result at step SP63 as a result of completing the issue of the foregoing local time designation command 41 to all storage apparatuses 3 that are registered in the time difference management table 31, it ends the execution operation reservation processing.

(4-6) Result Collection/Display Processing

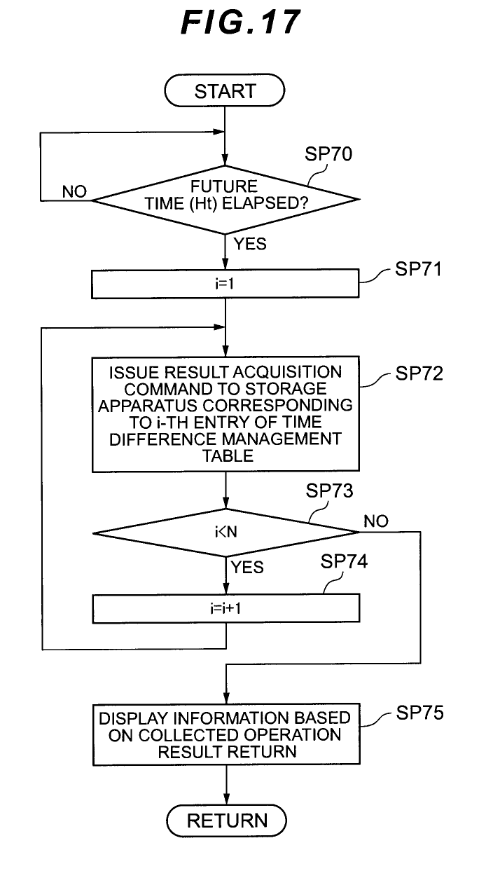

FIG. 17 shows the specific processing routine of the CPU 10 at step SP5 of FIG. 12. According to the processing routine shown in FIG. 17, the CPU 10 collects the operation result (operational information) of the operations that were reserved and set in the respective storage apparatuses based on the execution operation reservation processing of FIG. 16, and displays the collected operational information and the operational information of the overall remote copy system 1 that is calculated based on the foregoing operational information.

Specifically, when the CPU 10 proceeds to step SP5 of FIG. 12, it starts the result collection/display processing, and waits for the future time Ht decided at step SP60 of the execution operation reservation processing of FIG. 16 to elapse (SP70). When the host time eventually lapses the future time Ht, the CPU 10 resets the variable “i” to “1” (SP71).

Subsequently, the CPU 10 issues a result acquisition command to the storage apparatuses 3 in which the entry number in the time difference management table 31 corresponds with the “i”-th entry (SP72). Consequently, the storage apparatuses 3 that received the result acquisition command send, to the host apparatus 2, the operational information stored in the result storage buffer column 33E of the local time designation command management table 33 (FIG. 5) retained by such storage apparatuses 3.

The CPU 10 determines whether the value of the variable “i” is less than the number of storage apparatuses N registered in the time difference management table 31 (SP73). If the CPU 10 obtains a positive result in the foregoing determination, it increments the variable “i” (SP74), and thereafter returns to step SP72. The CPU 10 thereafter repeats the processing of step SP72 to step SP74 until it obtains a negative result at step SP73.

When the CPU 10 eventually obtains a negative result at step SP73 as a result of completing the issue of the result acquisition command to all storage apparatuses 3 registered in the time difference management table 31, it calculates the operational information (for example, the delay time of the secondary-side in relation to the primary-side in the asynchronous remote copy) of the overall remote copy system 1 based on the operational information obtained from the response from the respective storage apparatuses 3 in response to the result acquisition command. Moreover, the CPU 10 displays the calculation result on the host apparatus 2 (SP75), thereafter ends the result collection/display processing and returns to the processing of FIG. 12.

### (5) Effect of this Embodiment

With the remote copy system 1 according to this embodiment, since the host apparatus 2 seeks the time difference Dif(i) of the host time and the local time of the storage apparatus 3 for each storage apparatus 3, sets the time obtained by adding the arbitrary future time Ht to the sought time difference Dif(i) as the operation execution local time to the respective storage apparatuses 3, and collects the execution results of the operations that were executed at the operation execution local time from the respective storage apparatuses 3 after the lapse of the future time Ht, results of operations that were executed at the same time can be obtained from the respective storage apparatuses 3. Consequently, the operation results of the same point in time in a plurality of storage apparatuses can be acquired in a highly reliable manner.

Moreover, as a result of selecting a timeframe in which business operations are not being performed as the future time Ht, the operational information of the respective storage apparatuses 3 can be acquired without affecting the business operations.

### (6) Other Embodiments

Although the foregoing embodiment explained a case of applying the present invention to the remote copy system 1 configured as shown in FIG. 1, the present invention is not limited thereto, and can also be broadly applied to computer systems of various configurations that need to collect operational information of the same point in time from a plurality of storage apparatuses.

Moreover, although the foregoing embodiment explained a case of loading the function of the present invention in the host apparatus 2, the present invention is not limited thereto, and such function may also be loaded in another information processing apparatus such as a management server that is provided separately from the host apparatus 2.

In addition, although the foregoing embodiment explained a case of configuring the time difference detection unit for detecting a time difference between an internal time (local time) of the storage apparatus 3 and an internal time (host time) of the host apparatus 2 regarding each of the plurality of storage apparatuses 3, the operation execution setting unit for setting, to the respective storage apparatuses 3 at an arbitrary future time Ht, a time added with the time difference between the internal time of the storage apparatus 3 and the internal time of the host apparatus 2 as an execution time (operation execution local time) of a predetermined operation, and the execution result collection unit for collecting an execution result of the predetermined operation from the respective storage apparatuses 3 after the lapse of the future time Ht are configured from a single CPU 10 that governs the operational control of the overall host apparatus 2, the present invention is not limited thereto, and a part or all of the functions as the time difference detection unit, the operation execution setting unit and the execution result collection unit may be loaded in a CPU that is provided separately from the CPU 10, or hardware having the functions as the time difference detection unit, the operation execution setting unit and/or the execution result collection unit may be provided separately from the CPU 10.

The present invention can be broadly applied to information processing apparatuses in addition to host apparatuses in a remote copy system.

What is claimed is:

1. An information processing apparatus connected to a plurality of storage apparatuses, comprising:
a time difference detection unit for detecting a time difference between an internal time of the storage apparatus and an internal time of the information processing apparatus regarding each of the plurality of storage apparatuses;
an operation execution setting unit for setting, to the plurality of storage apparatuses at an arbitrary future time, a time added with the time difference between the internal time of the storage apparatus and the internal time of the information processing apparatus as an execution time of a predetermined operation; and
an execution result collection unit for collecting an execution result of the predetermined operation from each of the plurality of storage apparatuses after the lapse of the future time.

2. The information processing apparatus according to claim 1,
wherein the predetermined operation is an operation of acquiring operational information of the storage apparatus at the execution time, and
wherein the execution result collection unit collects the operational information of the storage apparatus as the execution result of the predetermined operation from each of the plurality of storage apparatuses, and displays the collected operational information of each of the storage apparatuses and information that is obtained based on the operational information.

3. The information processing apparatus according to claim 1,
wherein the plurality of storage apparatuses execute asynchronous remote copy, and
wherein the operational information is the acquisition of a last update time of data in a primary-side storage apparatus that is executing the asynchronous remote copy, and the acquisition of a last time stamp time of update data that is transferred from the primary-side storage apparatus in a secondary-side storage apparatus.

4. The information processing apparatus according to claim 1,
wherein the execution result collection unit displays the difference between a last update time of data in a primary-side storage apparatus and a last time stamp time of update data in a secondary-side storage apparatus based on the collected operation information of each of the storage apparatuses as a delay time of the primary-side and the secondary-side in the asynchronous remote copy.

5. The information processing apparatus according to claim 1,
wherein the time difference detection unit sends, twice, a command to the storage apparatus for acquiring and responding an internal time in the storage apparatus, and detects a time difference between the internal time of the storage apparatus and the internal time of the information processing apparatus based on the internal time of the storage apparatus at the time that the command was received as a result of sending each of the commands and the time interval from the time that each of the commands was sent to the storage apparatus until the time that the response of the command is received.

6. A method of controlling an information processing apparatus connected to a plurality of storage apparatuses, comprising:
a first step of detecting a time difference between an internal time of the storage apparatus and an internal time of the information processing apparatus regarding each of the plurality of storage apparatuses;
a second step of setting, to the plurality of storage apparatuses at an arbitrary future time, a time added with the time difference between the internal time of the storage apparatus and the internal time of the information processing apparatus as an execution time of a predetermined operation; and
a third step of collecting an execution result of the predetermined operation from each of the plurality of storage apparatuses after the lapse of the future time.

7. The method of controlling an information processing apparatus according to claim 6,
wherein the predetermined operation is an operation of acquiring operational information of the storage apparatus at the execution time, and
wherein, at the third step, the operational information of the storage apparatus is collected as the execution result of the predetermined operation from each of the plurality of storage apparatuses, and the collected operational information of each of the storage apparatuses and information that is obtained based on the operational information are displayed.

8. The method of controlling an information processing apparatus according to claim 6,
wherein the plurality of storage apparatuses execute asynchronous remote copy, and
wherein the operational information is the acquisition of a last update time of data in a primary-side storage apparatus that is executing the asynchronous remote copy, and the acquisition of a last time stamp time of update data that is transferred from the primary-side storage apparatus in a secondary-side storage apparatus.

9. The method of controlling an information processing apparatus according to claim 6,
wherein, at the third step, the difference between a last update time of data in a primary-side storage apparatus and a last time stamp time of update data in a secondary-side storage apparatus is displayed based on the collected operation information of each of the storage apparatuses as a delay time of the primary-side and the secondary-side in the asynchronous remote copy.

10. The method of controlling an information processing apparatus according to claim 6,
wherein, at the first step, a command is sent twice to the storage apparatus for acquiring and responding an internal time in the storage apparatus, and a time difference between the internal time of the storage apparatus and the internal time of the information processing apparatus is detected based on the internal time of the storage apparatus at the time that the command was received as a result of sending each of the commands and the time interval from the time that each of the commands was sent to the storage apparatus until the time that the response of the command is received.
